(19) United States
(12) Patent Application Publication
(10) Pub. No.: US 2026/0093655 A1
(43) Pub. Date: Apr. 2, 2026

(54) UNIVERSAL SERIAL BUS HUB AND CONTROL METHOD THEREOF

(71) Applicant: REALTEK SEMICONDUCTOR CORPORATION, HSINCHU (TW)

(72) Inventors: JIUNN-HUNG SHIAU, HSINCHU (TW); NENG-HSIEN LIN, HSINCHU (TW)

(21) Appl. No.: 19/345,719

(22) Filed: Sep. 30, 2025

(30) Foreign Application Priority Data
Oct. 1, 2024 (TW) 113137664

(51) Int. Cl. G06F 13/40; G06F 13/38; G06F 13/42

(52) U.S. Cl. CPC G06F 13/4081; G06F 13/382; G06F 13/4282; G06F 2213/0042; G06F 2213/3812

(57) ABSTRACT

A universal serial bus (USB) hub includes a first downstream facing port (DFP), an extensible host controller interface (xHCI), a second downstream facing port (DFP), a router, and an upstream facing port (UFP). The first downstream facing port (DFP) is configured to receive a first universal serial bus (USB) data. The extensible host controller interface (xHCI) is configured to convert the first universal serial bus (USB) data into a peripheral component interconnection express (PCIe) data. The second downstream facing port (DFP) is configured to receive a second universal serial bus (USB) data. The router is configured to convert the peripheral component interconnection express (PCIe) data into a first tunneling data, and convert the second universal serial bus (USB) data into a second tunneling data. The upstream facing port (UFP) is configured to output the first tunneling data and the second tunneling data.

### BACKGROUND OF THE INVENTION

### 1. Field of the Invention

The present disclosure relates to a universal serial bus hub and a control method thereof, especially to a universal serial bus hub and a control method thereof for providing independent bandwidth for universal serial bus.

### 2. Description of Related Art

The universal serial bus (USB) technology has been continuously advancing, and the fourth-generation universal serial bus (USB 4) has been released. To ensure compatibility with other protocols, such as the Thunderbolt protocol, the USB Implementers Forum (USB-IF) requires USB 4 hubs to be equipped with an extensible host controller interface (xHCI). However, the utilization rate of the extensible host controller interface is extremely low, which not only occupies hub area but also increases cost.

### SUMMARY OF THE INVENTION

In some aspects, an object of the present disclosure is to, but not limited to, provides a universal serial bus hub and a control method thereof that makes an improvement to the prior art.

An embodiment of a universal serial bus hub includes a first downstream facing port, an extensible host controller interface, a second downstream facing port, a router, and an upstream facing port. The first downstream facing port is configured to receive a first universal serial bus data. The extensible host controller interface is configured to convert the first universal serial bus data into a peripheral component interconnection express data. The second downstream facing port is configured to receive a second universal serial bus data. The router is configured to convert the peripheral component interconnection express data into a first tunneled data, and convert the second universal serial bus data into a second tunneled data. The upstream facing port is configured to output the first tunneled data and the second tunneled data.

An embodiment of a control method of a universal serial bus hub of the present disclosure which is executed by a processor reading at least one command includes following steps: receiving a first universal serial bus data by a first downstream facing port; converting the first universal serial bus data into a peripheral component interconnection express data by an extensible host controller interface; receiving a second universal serial bus data by a second downstream facing port; converting the peripheral component interconnection express data into a first tunneling data, and converting the second universal serial bus data into a second tunneling data by a router; and outputting the first tunneling data and the second tunneling data by an upstream facing port.

Technical features of some embodiments of the present disclosure make an improvement to the prior art. The universal serial bus hub and the control method thereof in the present disclosure can effectively utilize the extensible host controller interface to provide independent bandwidth, thereby avoiding the issues of larger hub area occupancy and increased cost resulting from the low utilization rate of the extensible host controller interface in the universal serial bus hub.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a universal serial bus hub of the present disclosure.

FIG. 2 shows an embodiment of a flow diagram of a control method of a universal serial bus hub of the present disclosure.

FIG. 3 shows an embodiment of a universal serial bus hub of the present disclosure.

FIG. 4 shows an embodiment of a universal serial bus hub of the present disclosure.

FIG. 5 shows an embodiment of a universal serial bus hub and a memory of the present disclosure.

### DETAILED DESCRIPTION OF THE PREFERRED EMBODIMENTS

To address the issues of larger hub area occupancy and increased cost resulting from the low utilization rate of the extensible host controller interface in the prior art, the present disclosure provides a universal serial bus hub and a control method thereof, which will be explained in detail as shown below.

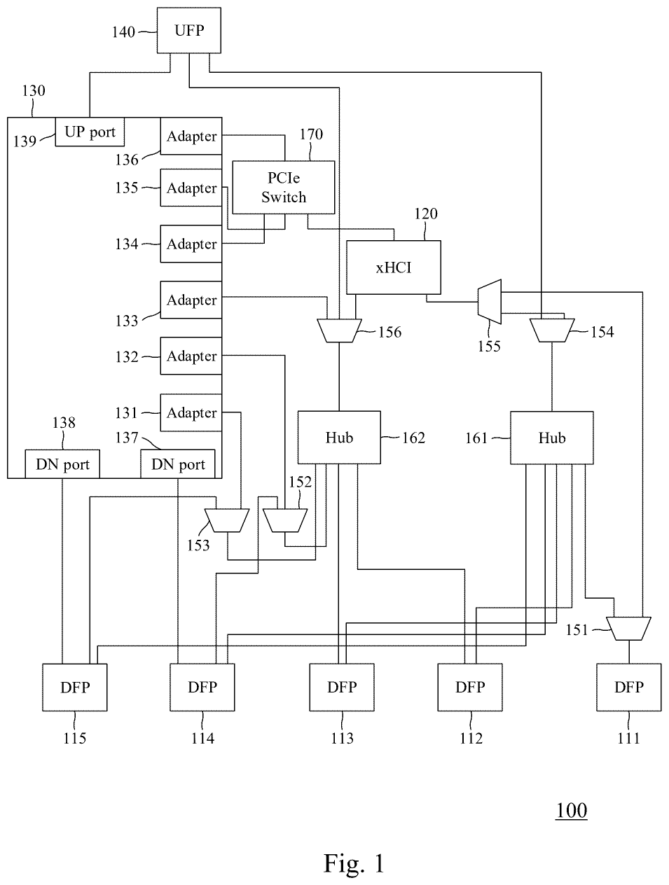

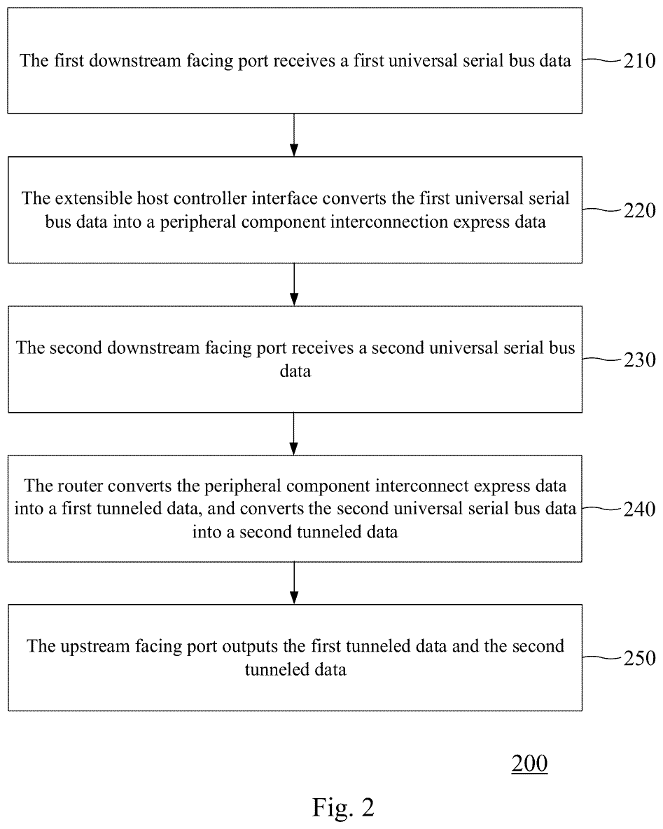

FIG. 1 shows an embodiment of a universal serial bus (USB) hub 100 of the present disclosure. As shown in the figure, the universal serial bus hub 100 includes a first downstream facing port (DFP) 111, an extensible host controller interface (xHCI) 120, a second downstream facing port (DFP) 113, a router 130, and an upstream facing port (UFP) 140. To facilitate the understanding of the operation of the universal serial bus hub 100, reference is made to FIG. 2, which is a flow diagram of a control method 200 of a universal serial bus hub of the present disclosure.

Referring to FIG. 1 and FIG. 2, in step 210, the first downstream facing port 111 receives a first universal serial bus data. In step 220, the extensible host controller interface 120 converts the first universal serial bus data into a peripheral component interconnection express (PCIe) data.

For example, assuming that the upstream facing port 140 is coupled to a fourth-generation universal serial bus (USB4) downstream facing port (not shown), the present disclosure operates in a universal serial bus transmission mode. The first downstream facing port 111 can be a second-generation universal serial bus (USB 2) downstream facing port (DFP), and the first universal serial bus data can be a second-generation universal serial bus data.

Assuming that the second-generation universal serial bus downstream facing port 111 is coupled to a universal serial bus upstream facing port (not shown), the present disclosure operates in a second-generation universal serial bus transmission mode with independent bandwidth. The second-generation universal serial bus downstream facing port 111 receives the second-generation universal serial bus data, and transmits the second-generation universal serial bus data to a multiplexer 151. Subsequently, the multiplexer 151 receives the second-generation universal serial bus data from the second-generation universal serial bus downstream facing port 111, and transmits the second-generation universal serial bus data to a multiplexer 155. In addition, the multiplexer 155 receives the second-generation universal serial bus data, and transmits the second-generation universal serial bus data to the extensible host controller interface (xHCI) 120.

Subsequently, the extensible host controller interface 120 converts the second-generation universal serial bus data into the peripheral component interconnect express (PCIe) data. A peripheral component interconnect express switch 170 receives the peripheral component interconnect express data from the extensible host controller interface 120, and transmits the peripheral component interconnect express data to the router 130.

In step 230, the second downstream facing port 113 receives a second universal serial bus data. In step 240, the router 130 converts the peripheral component interconnect express data into a first tunneling data, and converts the second universal serial bus data into a second tunneling data.

For example, the second downstream facing port 113 can be a third-generation universal serial bus (USB 3) downstream facing port, the second universal serial bus data can be a third-generation universal serial bus data, and a universal serial bus hub 162 can be a third-generation universal serial bus hub. The present disclosure can receive the third-generation universal serial bus data through the third-generation universal serial bus downstream facing port 113, and transmit the third-generation universal serial bus data to the third-generation universal serial bus hub 162. Subsequently, the third-generation universal serial bus hub 162 receives the third-generation universal serial bus data, and transmits the third-generation universal serial bus data to a multiplexer 156. Then, the multiplexer 156 receives the third-generation universal serial bus data, and transmits the third-generation universal serial bus data to the router 130. Furthermore, the router 130 converts the peripheral component interconnection express data into the first tunneling data (i.e., in accordance with tunneling protocol) that can be processed and transmitted by the router 130, and converts the third-generation universal serial bus data into the second tunneling data that can be processed and transmitted by the router 130.

In some embodiments, the router 130 includes peripheral component interconnection express adapters 134˜136. The peripheral component interconnection express adapters 134, 135 can be peripheral component interconnection express down adapters, and the peripheral component interconnection express adapter 136 can be a peripheral component interconnection express up adapter. In some embodiments, the peripheral component interconnection express up adapter 136 receives the peripheral component interconnection express data from the extensible host controller interface 120 through the peripheral component interconnection express switch 170, and converts the peripheral component interconnection express data into a tunneling data that can be processed and transmitted by the router 130.

In some embodiments, the router 130 includes universal serial bus adapters 131˜133. The universal serial bus adapters 131, 132 can be universal serial bus down adapters, and the universal serial bus adapter 133 can be a universal serial bus up adapter. In some embodiments, the universal serial bus up adapter 133 receives the third-generation universal serial bus data from the third-generation universal serial bus downstream facing port 113 through the multiplexer 156 and the hub 162, and converts the third-generation universal serial bus data into a tunneling data that can be processed and transmitted by the router 130.

In step 250, the upstream facing port 140 outputs the first tunneling data and the second tunneling data. For example, the upstream facing port 140 can be a fourth-generation universal serial bus (USB 4) upstream facing port (UFP), and the router 130 transmits the first tunneling data and the second tunneling data to the fourth-generation universal serial bus upstream facing port 140 through the up port 139. The fourth-generation universal serial bus upstream facing port 140 outputs the first tunneling data and the second tunneling data to a universal serial bus downstream facing port (not shown).

In view of the above, the universal serial bus hub 100 of the present disclosure not only can operate in a general universal serial bus transmission mode, wherein the downstream facing port 113 receives the universal serial bus data, and the router 130 converts the universal serial bus data into the tunneling data for outputting by the upstream facing port 140, but also can operate in a universal serial bus transmission mode with independent bandwidth, wherein the downstream facing port 111 receives the universal serial bus data, the extensible host controller interface 120 converts the universal serial bus data into the peripheral component interconnection express data, and the router 130 converts the peripheral component interconnection express data into the tunneling data for outputting by the upstream facing port 140, thereby providing additional independent bandwidth. Taking the downstream facing port 111 to be the second-generation universal serial bus downstream facing port as an example, the present disclosure can provide additional independent bandwidth of 480 Mbps. However, the present disclosure is not limited to the above embodiment, which is merely for illustrative purposes. In other embodiments, the downstream facing port 111 can be another type of port, and the number of the downstream facing port 111 can also be plural, depending on actual requirements.

In some embodiments, assuming the upstream facing port 140 is coupled to a Thunderbolt port (not shown), the present disclosure operates in a Thunderbolt mode. The second downstream facing port 113 can be a third-generation universal serial bus downstream facing port, and the second universal serial bus data can be a third-generation universal serial bus data. The present disclosure can receive the third-generation universal serial bus data through the third-generation universal serial bus port 113, and transmit the third-generation universal serial bus data to the hub 162. Subsequently, the hub 162 receives the third-generation universal serial bus data, and transmits the third-generation universal serial bus data to the multiplexer 156. Then, the multiplexer 156 receives the third-generation universal serial bus data, and transmits the third-generation universal serial bus data to the extensible host controller interface 120.

Next, the extensible host controller interface 120 receives the third-generation universal serial bus data, and converts the third-generation universal serial bus data into a peripheral component interconnection express data. Subsequently, the peripheral component interconnection express up adapter 136 of the router 130 receives the peripheral component interconnection express data from the extensible host controller interface 120 through the peripheral component interconnection express switch 170, and converts the peripheral component interconnection express data into a tunneling data that can be processed and transmitted by the router 130. Additionally, the router 130 transmits the tunneling data to the upstream facing port 140 through the up port 139, and the upstream facing port 140 outputs the tunneling data to a universal serial bus downstream facing port (not shown). Therefore, it is understood that the universal serial bus hub 100 of the present disclosure can also compatibly operate in the Thunderbolt mode.

In some embodiments, the universal serial bus hub 100 further includes a third downstream facing port (DFP) 112, and the third downstream facing port 112 is configured to receive a third universal serial bus data. The universal serial bus hub 161 is configured to process and transmit the third universal serial bus data to the upstream facing port 140, and the upstream facing port 140 outputs the third universal serial bus data. For example, the third universal serial bus data can be a second-generation universal serial bus data, and the universal serial bus hub 161 can be a second-generation universal serial bus hub. The third downstream facing port 112 is configured to receive the second-generation universal serial bus data, and transmit the second-generation universal serial bus data to the second-generation universal serial bus hub 161. Subsequently, the second-generation universal serial bus hub 161 is configured to process the second-generation universal serial bus data, and transmit the second-generation universal serial bus data to the upstream facing port 140 through a multiplexer 154, and the upstream facing port 140 outputs the second-generation universal serial bus data. Therefore, it is understood that the universal serial bus hub 100 of the present disclosure can also compatibly operate in a general second-generation universal serial bus transmission mode.

In some embodiments, the downstream facing port 111 can be a second-generation universal serial bus downstream facing port, the downstream facing ports 112, 113 can be third-generation universal serial bus downstream facing ports, the downstream facing ports 114, 115 can be fourth-generation universal serial bus downstream facing ports, the router 130 can be a fourth-generation universal serial bus router, the down ports 137, 138 can be fourth-generation universal serial bus down ports, the up port 139 can be a fourth-generation universal serial bus up port, the upstream facing port 140 can be a fourth-generation universal serial bus upstream facing port, the universal serial bus hub 161 can be a second-generation universal serial bus hub, and the universal serial bus hub 162 can be a third-generation universal serial bus hub. However, the present disclosure is not limited to the above embodiment, which is merely for illustrative purposes.

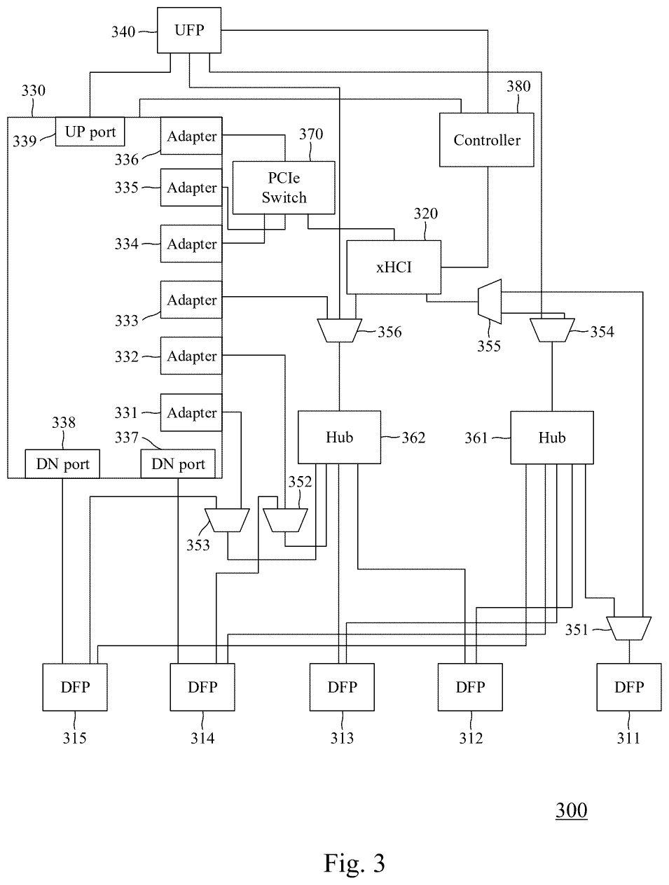

FIG. 3 shows an embodiment of a universal serial bus hub 300 of the present disclosure. Compared with the universal serial bus hub 100 of FIG. 1, the universal serial bus hub 300 of FIG. 3 further includes a controller 380. Assuming that the second-generation universal serial bus port 311 is not coupled to a universal serial bus upstream facing port (not shown), the present disclosure operates in a general universal serial bus transmission mode. The controller 380 disables the extensible host controller interface 320. In addition, the router 330 only converts a received universal serial bus data into a tunneling data, and the upstream facing port 140 then outputs the tunneling data. Therefore, it is understood that the universal serial bus hub 300 of the present disclosure can also compatibly operate in a general universal serial bus transmission mode without independent bandwidth. For example, the universal serial bus hub 300 of the present disclosure can operate in a general fourth-generation universal serial bus transmission mode.

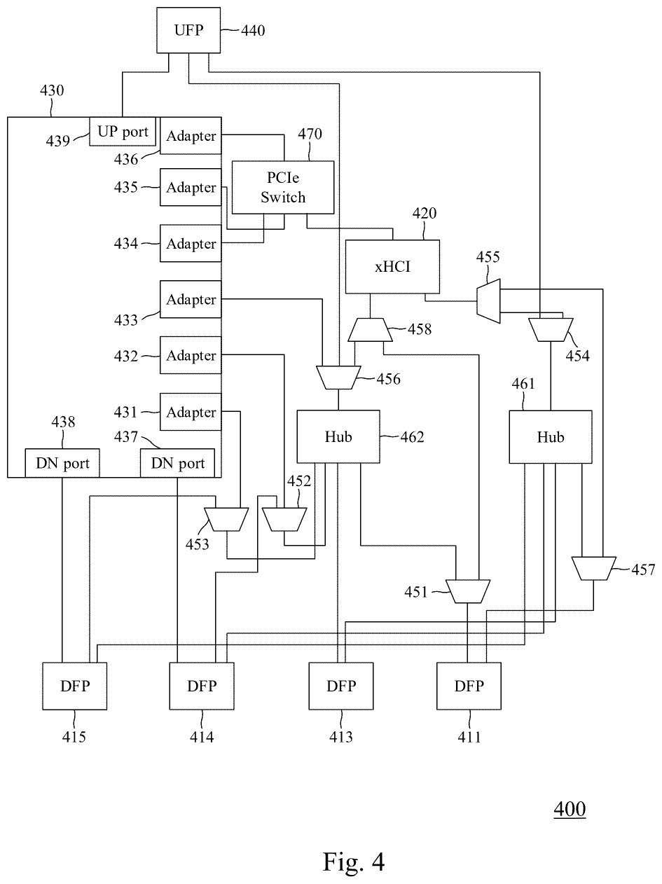

FIG. 4 shows an embodiment of a universal serial bus hub 400 of the present disclosure. Assuming that the upstream facing port 440 is coupled to a fourth-generation universal serial bus downstream facing port (not shown), the present disclosure operates in a universal serial bus transmission mode. The first downstream facing port 411 and the second downstream facing port 413 can be third-generation universal serial bus downstream facing ports.

Assuming that the third-generation universal serial bus port 411 is coupled to a universal serial bus upstream facing port (not shown), the present disclosure operates in a third-generation universal serial bus transmission mode with independent bandwidth. The third-generation universal serial bus port 411 receives a third-generation universal serial bus data, and transmits the third-generation universal serial bus data to the multiplexer 451. Subsequently, the multiplexer 451 receives the third-generation universal serial bus data from the third-generation universal serial bus port 411, and transmits the third-generation universal serial bus data to the multiplexer 458. In addition, the multiplexer 458 receives the third-generation universal serial bus data, and transmits the third-generation universal serial bus data to the extensible host controller interface 420.

Subsequently, the extensible host controller interface 420 converts the third-generation universal serial bus data into a peripheral component interconnection express data. Furthermore, the peripheral component interconnection express switch 470 receives the peripheral component interconnection express data from the extensible host controller interface 420, and transmits the peripheral component interconnection express data to the router 430.

In another aspect, the present disclosure receives the third-generation universal serial bus data from the third-generation universal serial bus port 413, and transmits the third-generation universal serial bus data to the hub 462. Subsequently, the hub 462 receives the third-generation universal serial bus data, and transmits the third-generation universal serial bus data to the multiplexer 456. Then, the multiplexer 456 receives the third-generation universal serial bus data, and transmits the third-generation universal serial bus data to the router 430. Furthermore, the router 430 converts the peripheral component interconnection express data received from the peripheral component interconnection express switch 470 into a first tunneling data that can be processed and transmitted by the router 430, and converts the third-generation universal serial bus data received from the multiplexer 456 into a second tunneling data that can be processed and transmitted by the router 430. Next, the router 430 transmits the first tunneling data and the second tunneling data to the upstream facing port 440 through the up port 439, and the upstream facing port 440 outputs the first tunneling data and the second tunneling data to a universal serial bus downstream facing port (not shown).

In view of the above, the universal serial bus hub 400 of the present disclosure not only can operate in a general universal serial bus transmission mode, wherein the downstream facing port 413 receives the universal serial bus data, and the router 430 converts the universal serial bus data into the tunneling data for outputting by the upstream facing port 440, but also can operate in a universal serial bus transmission mode with independent bandwidth, wherein the downstream facing port 411 receives the universal serial bus data, the extensible host controller interface 420 is used to convert the universal serial bus data into the peripheral component interconnection express data, and the router 430 then converts the peripheral component interconnection express data into the tunneling data for outputting by the upstream facing port 440, thereby providing additional independent bandwidth. Taking the downstream facing port 411 to be the third-generation universal serial bus port as an example, the present disclosure can provide additional independent bandwidth of 10 Gbps. However, the present disclosure is not limited to the above embodiment, which is merely for illustrative purposes. In other embodiments, the downstream facing port 411 can be another type of port, and the number of downstream facing port 411 can be plural, depending on actual requirements.

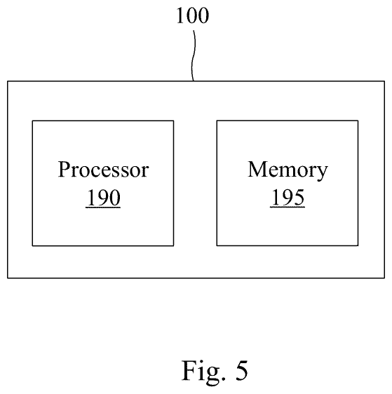

FIG. 5 shows an embodiment of a universal serial bus hub 100 of the present disclosure. As shown in the figure, the processor 190 and the memory 195 can be embedded in the universal serial bus hub 100 of the present disclosure. The present disclosure can implement the control method 200 of the universal serial bus hub shown in FIG. 2 through the processor 190 performing at least one command. For example, the present disclosure can perform at least one command stored in the memory 195 through the processor 190 to execute related control operations, so as to control the various devices/components shown in FIG. 1, FIG. 3, and FIG. 4 to perform the control method 200 of the universal serial bus hub in FIG. 2.

It should be noted that the present disclosure is not limited to the embodiments as shown in FIG. 1 to FIG. 5, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The universal serial bus hub and the control method thereof in the present disclosure can effectively utilize the extensible host controller interface to provide independent bandwidth, thereby avoiding the issues of larger hub area occupancy and increased cost resulting from the low utilization rate of the extensible host controller interface in the universal serial bus hub.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A universal serial bus hub, comprising:
a first downstream facing port, configured to receive a first universal serial bus data;
an extensible host controller interface, configured to convert the first universal serial bus data into a peripheral component interconnection express data;
a second downstream facing port, configured to receive a second universal serial bus data;
a router, configured to convert the peripheral component interconnection express data into a first tunneling data, and convert the second universal serial bus data into a second tunneling data; and
an upstream facing port, configured to output the first tunneling data and the second tunneling data.

2. The universal serial bus hub of claim 1, further comprising:
at least one multiplexer, configured to receive the first universal serial bus data from the first downstream facing port, and transmit the first universal serial bus data to the extensible host controller interface.

3. The universal serial bus hub of claim 1, further comprising:
a peripheral component interconnection express switch, configured to receive the peripheral component interconnection express data from the extensible host controller interface, and transmit the peripheral component interconnection express data to the router.

4. The universal serial bus hub of claim 1, wherein the router comprises:
a peripheral component interconnection express adapter, configured to convert the peripheral component interconnection express data into the first tunneling data.

5. The universal serial bus hub of claim 1, wherein the router comprises:
a universal serial bus adapter, configured to convert the second universal serial bus data into the second tunneling data.

6. The universal serial bus hub of claim 1, wherein the upstream facing port is coupled to a universal serial bus downstream facing port, wherein the first downstream facing port comprises a second-generation universal serial bus port, and the first universal serial bus data comprises a second-generation universal serial bus data, wherein the extensible host controller interface is configured to convert the second-generation universal serial bus data into the peripheral component interconnection express data; and
wherein the second downstream facing port comprises a third-generation universal serial bus port, and the second universal serial bus data comprises a third-generation universal serial bus data, wherein the router is configured to convert the peripheral component interconnection express data into the first tunneling data, and convert the third-generation universal serial bus data into the second tunneling data.

7. The universal serial bus hub of claim 1, wherein the upstream facing port is coupled to a thunderbolt port, wherein the extensible host controller interface is configured to convert the second universal serial bus data into another peripheral component interconnection express data, the router is configured to convert the another peripheral component interconnection express data into a third tunneling data, and the upstream facing port is configured to output the third tunneling data.

8. The universal serial bus hub of claim 1, further comprising:
a third downstream facing port, configured to receive a third universal serial bus data; and
a universal serial bus hub, configured to process and transmit the third universal serial bus data to the upstream facing port, and the upstream facing port outputs the third universal serial bus data.

9. The universal serial bus hub of claim 1, further comprising:
a controller, configured to disable the extensible host controller interface, wherein the router only converts the second universal serial bus data into the second tunneling data, and the upstream facing port outputs the second tunneling data.

10. The universal serial bus hub of claim 1, wherein the first downstream facing port comprises a third-generation universal serial bus port, and the first universal serial bus data comprises a third-generation universal serial bus data, wherein the extensible host controller interface is configured to convert the third-generation universal serial bus data into the peripheral component interconnection express data;
wherein the second downstream facing port comprises another third-generation universal serial bus port, and the second universal serial bus data comprises another third-generation universal serial bus data, wherein the router is configured to convert the peripheral component interconnection express data into the first tunneling data, and convert the another third-generation universal serial bus data into the second tunneling data.

11. A control method of a universal serial bus hub, which is performed by a processor reading at least one command, comprising:
receiving a first universal serial bus data by a first downstream facing port;
converting the first universal serial bus data into a peripheral component interconnection express data by an extensible host controller interface;
receiving a second universal serial bus data by a second downstream facing port;
converting the peripheral component interconnection express data into a first tunneling data, and converting the second universal serial bus data into a second tunneling data by a router; and
outputting the first tunneling data and the second tunneling data by an upstream facing port.

12. The control method of claim 11, further comprising:
receiving the first universal serial bus data from the first downstream facing port, and transmitting the first universal serial bus data to the extensible host controller interface by at least one multiplexer.

13. The control method of claim 11, further comprising:
receiving the peripheral component interconnection express data from the extensible host controller interface, and transmitting the peripheral component interconnection express data to the router by a peripheral component interconnection express switch.

14. The control method of claim 11, wherein converting the peripheral component interconnection express data into the first tunneling data by the router comprises:
converting the peripheral component interconnection express data into the first tunneling data by a peripheral component interconnection express adapter of the router.

15. The control method of claim 11, wherein converting the second universal serial bus data into the second tunneling data by the router comprises:
converting the second universal serial bus data into the second tunneling data by a universal serial bus adapter of the router.

16. The control method of claim 11, further comprising:
coupling the upstream facing port to a universal serial bus downstream facing port;
wherein the first downstream facing port comprises a second-generation universal serial bus port, and the first universal serial bus data comprises a second-generation universal serial bus data, wherein converting the first universal serial bus data into the peripheral component interconnection express data by the extensible host controller interface comprises:
converting the second-generation universal serial bus data into the peripheral component interconnection express data by the extensible host controller interface; and
wherein the second downstream facing port comprises a third-generation universal serial bus port, and the second universal serial bus data comprises a third-generation universal serial bus data, wherein converting the peripheral component interconnection express data into the first tunneling data, and converting the second universal serial bus data into the second tunneling data by the router comprises:
converting the peripheral component interconnection express data into the first tunneling data, and converting the third-generation universal serial bus data into the second tunneling data by the router.

17. The control method of claim 11, further comprising:
coupling the upstream facing port to a thunderbolt port;
converting the second universal serial bus data into another peripheral component interconnection express data by the extensible host controller interface;
converting the another peripheral component interconnection express data into a third tunneling data by the router; and
outputting the third tunneling data by the upstream facing port.

18. The control method of claim 11, further comprising:
receiving a third universal serial bus data by a third downstream facing port;
processing and transmitting the third universal serial bus data to the upstream facing port by a universal serial bus hub; and
outputting the third universal serial bus data by the upstream facing port.

19. The control method of claim 11, further comprising:
disabling the extensible host controller interface by a controller;
wherein converting the peripheral component interconnection express data into the first tunneling data, and converting the second universal serial bus data into the second tunneling data by the router comprises:
only converting the second universal serial bus data into the second tunneling data by the router; and
wherein outputting the first tunneling data and the second tunneling data by the upstream facing port comprises:
outputting the second tunneling data by the upstream facing port.

20. The control method of claim 11, wherein the first downstream facing port comprises a third-generation universal serial bus port, and the first universal serial bus data comprises a third-generation universal serial bus data, wherein converting the first universal serial bus data into the peripheral component interconnection express data by the extensible host controller interface comprises:
converting the third-generation universal serial bus data into the peripheral component interconnection express data by the extensible host controller interface; and
wherein the second downstream facing port comprises another third-generation universal serial bus port, and the second universal serial bus data comprises another third-generation universal serial bus data, wherein converting the peripheral component interconnection express data into the first tunneling data, and converting the second universal serial bus data into the second tunneling data by the router comprises:
converting the peripheral component interconnection express data into the first tunneling data, and converting the another third-generation universal serial bus data into the second tunneling data by the router.
